(19) United States
(12) Patent Application Publication
(10) Pub. No.: US 2009/0102204 A1
(43) Pub. Date: Apr. 23, 2009

(54) GATE LATCH EXTENSION HANDLE

(76) Inventor: Eddie Hilliard, Atlantic Beach, FL (US)

Correspondence Address: MARK YOUNG, P.A., 12086 FORT CAROLINE ROAD, UNIT 202, JACKSONVILLE, FL, 32225, US

(21) Appl. No.: 11/876,900

(22) Filed: Oct. 23, 2007

(51) Int. Cl. E05C 1/12

(52) U.S. Cl. 292/139

(57) ABSTRACT

A gate latch extension handle assembly configured for pivotally engaging a latch arm of a hinged catch of a gate latch assembly on a same side of a gate as the gate latch assembly includes a vertical member with a means for pivotal attachment to the latch arm of the hinged catch of the gate latch assembly. A guide bracket has a guide channel sized and shaped to slidingly receive a portion of the vertical member and allow and guide vertical reciprocating movement of the vertical member through the guide channel. A horizontal member attached to the top end of and perpendicular to the vertical member. The vertical member transmits to the latch arm force exerted on the horizontal member. Components may optionally include a phosphorescent polymer coating or additive to glow in the dark. A removable, permanently attached or integrally formed handgrip surrounds at least a portion of the horizontal member. Optionally, an adjustable extension is attached to the bottom end of the vertical member.

### FIELD OF THE INVENTION

This invention generally relates to gates, and more particularly, to a gate latch extension handle configured to attach to a gate latch and extend upwardly on the latch side of a fence.

### BACKGROUND

Gate latches are used for latching a swingable member such as a swinging door or gate to a relatively fixed member such as a frame or post. Conventional latches include a latching bar which is rigidly fixed to a face of the swingable member and projects beyond the face edge thereof, a strike fixed to the relatively fixed member and having a portion projecting outwardly therefrom and formed with an outward opening positioned to receive the latching bar and a latching hinged catch pivotally supported in the projecting portion of the strike in position to engage and retain the latching bar in latching position. When the swingable member is moved into closed position, the latching bar enters the opening in the strike and cams up the latching hinged catch. Upon further movement of the bar into latching position, the hinged catch falls by gravity into latching relation with the bar. The latch can only be unlatched by raising the hinged catch out of latching relation with the bar.

Actuators designed to engage the latch from the opposite side of the gate may not be provided for safety and security purposes. By way of example, in the case of a fence surrounding a pool, the fence must prevent a child from going over, under, or through it to get to the pool. Actuators designed to engage the latch from the opposite side of the gate may also be omitted when a potentially dangerous animal, such as a dog, is fenced behind the gate. Such fences may be six (6) feet or more in height. They typically lack exterior handholds or footholds on which a child can climb. The gate is typically self closing and latching so that it does not accidentally remain open. Child-resistant latches are installed on the pool-side (or animal-side) of the gate. Opening such a gate from the side opposite the latch can be quite difficult or impossible even for an adult, unless the latch can be reached over the gate from the opposite side. In the case of a 6-foot or taller gate, reaching over the top of the gate and down to the latch is often impossible. Thus, an adult cannot enter through the gate from the side opposite the latch.

A device is needed to facilitate actuating a gate latch. The device should be located on the latch side of the gate/fence. The device should also be easy for an adult to access and use. The device should be reliable and work with conventional gate latches. The invention is directed to overcoming one or more of the problems and solving one or more of the needs as set forth above.

### SUMMARY OF THE INVENTION

To solve one or more of the problems set forth above, in an exemplary implementation of the invention, a gate latch extension handle assembly configured for pivotally engaging a latch arm of a hinged catch of a gate latch assembly on a same side of a gate as the gate latch assembly is provided. In one embodiment, the gate latch extension handle assembly includes a vertical member having a first width and a first length, a bottom end and a top end, and a means for pivotal attachment to the latch arm of the hinged catch of the gate latch assembly. A guide bracket has a guide channel sized and shaped to slidingly receive a portion of the vertical member and allow and guide vertical reciprocating movement of the vertical member through the guide channel. A horizontal member attached to the top end of and perpendicular to the vertical member has a second width and a second length, and the vertical member transmitting to the latch arm force exerted on the horizontal member.

The first length may be 2 to 12 inches. The second length may be 2 to 6 inches. Optionally, the gate latch extension handle assembly includes a phosphorescent polymer coating in an amount effective to absorb energy from solar radiation and continue to release that energy as visible light in dark conditions, thus providing a glow in the dark effect. The means for pivotal attachment to the latch arm of the hinged catch of the gate latch assembly may include a clevis pin and aperture, such as a circular or elongate aperture. The horizontal member may be fixedly or adjustably (e.g., pivotally) attached to the top end of and perpendicular to the vertical member. The horizontal member may be attached to the vertical member by at least one intermediate member.

A handgrip surrounds at least a portion of the horizontal member. The handgrip may be removable or integral. In one embodiment, the hand grip is hollow and includes an open end, an interior compartment and an exterior gripping surface. At least a portion of the horizontal member may be received through the open end and into the interior compartment. Optionally, the hand grip may be composed of an elastomer and a phosphorescent polymer additive in an amount effective to absorb energy from solar radiation and continue to release that energy as visible light in dark conditions, thus providing a glow in the dark effect.

The guide bracket includes a u-shaped body defining a vertical guide channel through which a portion of the vertical member is slidingly disposed. The channel has a depth, which is greater than the first width of the vertical member, allowing and guiding reciprocating motion of the vertical member without binding. A pair of mounting tabs extend from opposite sides of the u-shaped body. Each of the pair of mounting tabs include at least one mounting hole.

In another embodiment, the gate latch extension handle assembly includes an adjustable extension means attached to the bottom end of the vertical member. The adjustable extension means attached to the bottom end of the vertical member may be a hollow adjustable extension sleeve attached to the bottom end of the vertical member. The extension sleeve includes a longitudinal aperture on each of two opposite sides of the extension sleeve. The longitudinal apertures define a range of adjustment. The sleeve may be 3 to 12 inches in length. The sleeve also includes an extension sleeve attachment means for pivotal attachment to the latch arm of the hinged catch of the gate latch assembly. The extension sleeve attachment means includes a clevis pin and an aperture, such as a circular or elongate aperture.

### BRIEF DESCRIPTION OF THE DRAWINGS

The foregoing and other aspects, objects, features and advantages of the invention will become better understood with reference to the following description, appended claims, and accompanying drawings, where:

FIG. 1 shows a front perspective exploded view of an exemplary gate latch extension handle assembly according to principles of the invention; and

FIG. 2 shows a back perspective exploded view of an exemplary gate latch extension handle assembly according to principles of the invention; and

FIG. 3 shows a front perspective assembled view of an exemplary gate latch extension handle assembly according to principles of the invention; and

FIG. 4 shows a back perspective assembled view of an exemplary gate latch extension handle assembly according to principles of the invention; and

FIG. 5 shows a front perspective assembled view of an exemplary gate latch extension handle assembly operably coupled to a conventional gate latch according to principles of the invention; and

FIG. 6 shows a front perspective assembled view of an exemplary adjustable gate latch extension handle assembly according to principles of the invention; and

FIGS. 7, 8 and 9 show perspective views of exemplary handles (i.e., extension bodies) for an adjustable gate latch extension handle assembly according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the latch, shapes, relative sizes, ornamental aspects or proportions shown in the figures.

### DETAILED DESCRIPTION

Referring to the Figures, in which like parts are indicated with the same reference numerals, various views of exemplary gate latch extension handle assemblies 100 and components thereof according to principles of the invention are shown. The assembly includes a vertical member with a means for pivotal attachment to the latch arm of the hinged catch of the gate latch assembly. A guide bracket has a guide channel sized and shaped to slidingly receive a portion of the vertical member and allow and guide vertical reciprocating movement of the vertical member through the guide channel. A horizontal member attached to the top end of and perpendicular to the vertical member. The vertical member transmits to the latch arm force exerted on the horizontal member. Components may optionally include a phosphorescent polymer coating or additive to glow in the dark. A removable, permanently attached or integrally formed handgrip surrounds at least a portion of the horizontal member. Optionally, an adjustable extension is attached to the bottom end of the vertical member.

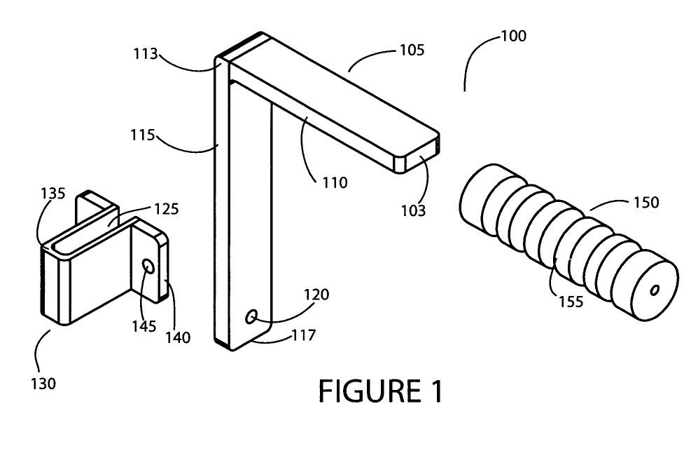

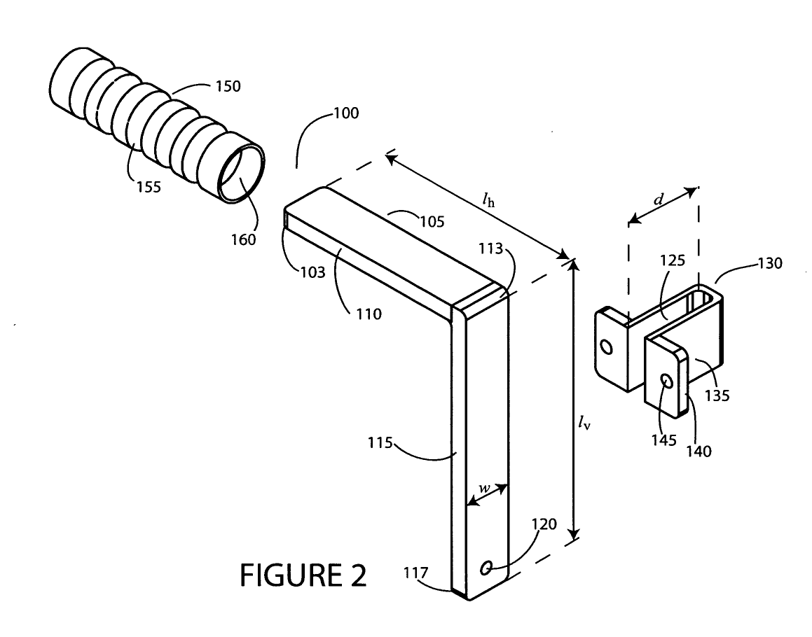

As shown in FIGS. 1 and 2, a generally L-shaped extension body 105 is provided as a handle for pivotally engaging a hinged catch of a gate latch assembly. The generally L-shaped extension body 105 includes a vertical arm 115 having a free end 117 at the bottom. The vertical arm defines the extension length, lᵥ, which may be 2 to 24 inches, preferably 3 to 12 inches, and more preferably 4 to 6 inches. A latch aperture 120 is provided near the free end 117 of the vertical arm 115 as a means for pivotally engaging a hinged catch of a gate latch assembly. A horizontal arm 110 of length lₕ extends perpendicularly from the top end 113 of the vertical arm 115. The horizontal arm 110 includes a free end 103. The horizontal arm 110 transmits pulling force exerted by a user to the vertical arm 115. The length of the horizontal arm 110, lₕ, defines the length of the handle and distance of the free end of the handle from the vertical arm. The length, lₕ, may be 2 to 12 inches, preferably 2 to 6 inches, and more preferably 3 inches.

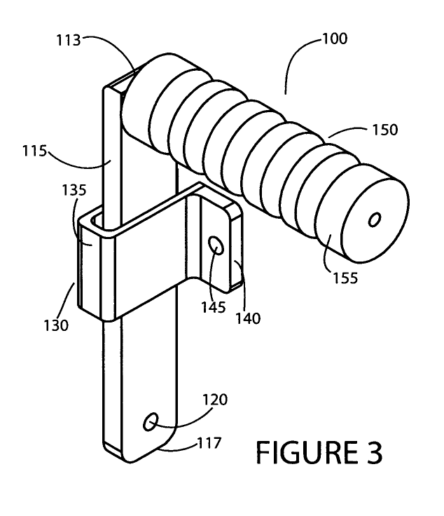

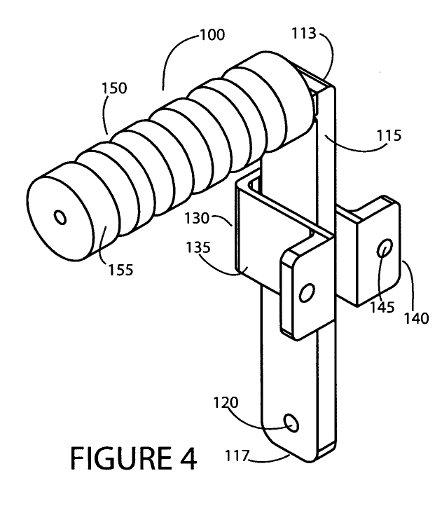

A hand grip 150 is provided to facilitate grasping the extension body 105, as shown in FIGS. 1 through 6. The hand grip 150 includes an open end 160 and a gripping surface 155, which may be ergonomically textured or contoured. The hand grip 150 is configured to receive a portion or the entirety of the horizontal arm 105 through the open end 160. The hand grip is preferably resilient, of sufficient length to permit a hand to grasp it reliably, with a sufficiently small circumference to permit a hand to surround it far enough to grasp it solidly but a sufficiently large circumference to distribute force comfortably over the hand, and provides friction against the hand, thereby reducing the gripping force needed to achieve a reliable grip. The hand grip 150 may be a removable separate component, molded onto the horizontal arm 110 or integrally formed with the horizontal arm 110.

The hand grip 150 may be comprised of a weather-proof plastic or elastomer, such as, for example, natural rubber, synthetic polyisoprene, butyl rubber, polybutadiene, nitrile rubber, chloroprene rubber, neoprene, ethylene propylene rubber, ethylene propylene diene rubber, epichlorohydrin rubber, polyacrylic rubber, silicone rubber, fluorosilicone rubber, fluoroelastomers, perfluoroelastomers, polyether block amides, chlorosulfonated polyethylene, ethylene-vinyl acetate, thermoplastic elastomers, thermoplastic vulcanizates, polyurethane rubber, or polysulfide rubber. While many other materials may be used alone or in combination with the aforementioned materials and/or other materials, without departing from the scope of the present invention, preferably the material is relatively inexpensive, easy to use in manufacturing operations and results in an aesthetically acceptable, durable, weather resistant product. The material may further include additives to provide desired properties such as glow-in-the dark properties.

By way of example and not limitation, a phosphorescent polymer additive or coating, such as aluminate based phosphors, may be included in the hand grip 150 material to absorb energy from solar radiation and continue to release that energy as visible light after the energy source is removed, i.e., at nighttime. Advantageously, such an embodiment provides a hand grip 150 that is easy to locate in darkened conditions, making it easy to spot even at nighttime.

A guide bracket 130, as shown in FIGS. 1, 2 and 5, is provided to support and guide the L-Shaped extension body 105. The guide bracket 130 includes a u-shaped body 135 defining a vertical passageway 125 through which the vertical arm 115 is slidingly disposed. The depth d of the passageway 125 is greater than the width w of the vertical arm 115, allowing and guiding reciprocating motion of the L-shaped extension body 105, without binding. This extra space provides ample room for vertical and lateral movement of the vertical arm 115 when pivotally attached to a gate latch. A pair of mounting tabs 140, with mounting holes 145, attached to the body 135 enable attachment of the guide bracket 130 to a support structure such as a fence post.

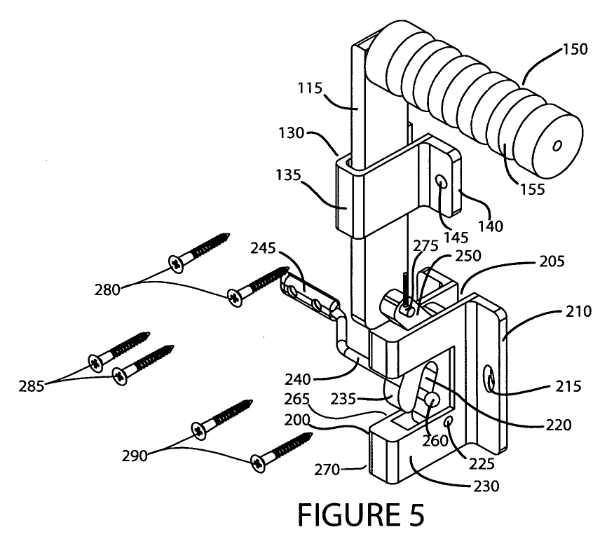

Referring now to FIG. 5, a front perspective assembled view of an exemplary gate latch extension handle assembly 100 operably coupled to a conventional gate latch assembly 200 according to principles of the invention is shown. The guide bracket 130, is attached to the support (e.g., a fence post) for the gate latch assembly 200. A plurality of wood screws 280 may be used to secure the guide bracket 130 to the fence post. The guide bracket 130 supports and guides the L-Shaped extension body 105. A latching bar 240 with an attachment base 245 and bulbous free end 260 is rigidly fixed to a face of the swingable member, such as a gate (not shown), and projects beyond the face edge thereof. A plurality of wood screws 285 may be used to secure the base 245 to a gate. A strike 230 fixed to a relatively fixed member such as a fence post (not shown) has a portion 270 projecting outwardly therefrom with an outward opening 265 positioned to receive the latching bar 240. A plurality of wood screws 290 may be used to secure the strike 230 to a fence post. A latching hinged catch 235 with a groove 220 is pivotally supported by a pivot pin 225 in a channel 205 formed in the projecting portion of the strike 230 in position to engage and retain the latching bar 240 in the groove 220 in a latching position. A latch arm 250 attached to the hinged catch 235 extends upwardly. A pair of mounting tabs 210b with mounting holes 215 extend from the sides of the strike 230. When the swingable member is moved into closed position, the latching bar 240 enters the opening in the strike 230 and cams up the latching hinged catch 235. Upon further movement of the bar 240 into latching position, the hinged catch 235 falls by gravity into latching relation with the bar 240. Unlatching is accomplished by raising the hinged catch 235 out of latching relation with the bar 240. A screw and nut, or a clevis pin 275 with either a cotter pin or snap ring, pivotally couple the vertical arm 115 through the aperture 120 to the latch arm 250 through a corresponding aperture 255.

In use, a user reaches over a fence or gate, grasps the hand grip 150, and urges it upwardly until the hinged catch 235 pivots out of latching relation with the bar 240. Upward movement of the gate latch extension handle body relative to the bracket 130 is transmitted to the pivotally attached latch arm 250, which moves the hinged catch 235 out of latching relation with the bar 240. Releasing the hand grip 150, allows the handle body and pivotally coupled hinged catch 235 to fall to the latched position under the influence of gravity. Urging the latching bar 240 into the opening of the strike 230, cams up the latching hinged catch 235 as well as the pivotally coupled gate latch extension handle body. Upon further movement of the bar 240 into latching position, the hinged catch 235 and gate latch extension handle body fall by gravity into latching relation with the bar 240.

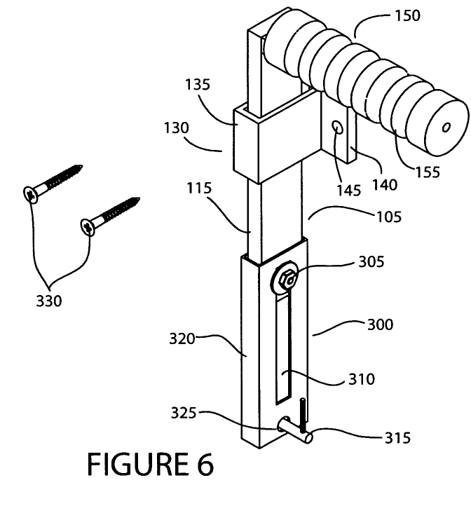

FIG. 6 shows a front perspective assembled view of an exemplary adjustable gate latch extension handle assembly according to principles of the invention. A telescopic hollow adjustable extension sleeve 300 slidingly attaches to the vertical arm 115. The extension sleeve 300 includes a hollow body 320 with a longitudinal aperture 310 on each of two opposite sides of the body 320. The longitudinal apertures 310 define the range of adjustment. The body 320 may be 2 to 24 inches, preferably 3 to 12 inches, and more preferably 4 to 6 inches in length, with the longitudinal apertures 310 extending fifty to ninety-five percent of that length. A screw, washer and nut 305 securely couple the extension sleeve 300 through the longitudinal aperture 310 to the vertical arm 115 through the aperture 120. The bottom of the extension sleeve body 320 includes an aperture 325 for pivotally coupling the extension sleeve 300 to the latch arm 250. A screw and nut, or a clevis pin 315 with either a cotter pin or snap ring, pivotally couple the extension sleeve 115 through the aperture 325 to the latch arm 250 through a corresponding aperture 255.

The gate latch extension handle assembly 100 is preferably sufficiently strong and weather resistant such that it does not structurally fail from the stresses and environmental conditions encountered during use. The gate latch extension handle assembly 100 may be comprised of various materials, such as metal and/or plastic. In an exemplary embodiment, the gate latch extension handle assembly 100 (except the hand grip 150) is comprised of a steel, stainless steel, tool steel, aluminum, other metals or alloys thereof. In another embodiment, the gate latch extension handle assembly 100 is comprised of rigid plastic or polymeric material, such as polyvinyl chloride (PVC), polyethylene, polypropylene, polystyrene, acrylics, cellulosics, acrylonitrile-butadiene-styrene terpolymers, urethanes, thermo-plastic resins, thermo-plastic elastomers (TPE), acetal resins, polyamides, polycarbonates and polyesters. While many other materials may be used alone or in combination with the aforementioned materials and/or other materials, without departing from the scope of the present invention, preferably the material is relatively inexpensive, easy to use in manufacturing operations and results in an aesthetically acceptable, durable, weather resistant product. The material may further include additives to provide desired properties such as glow-in-the dark properties.

By way of example and not limitation, a phosphorescent polymer additive or coating, such as aluminate based phosphors, may be included to absorb energy from solar radiation and continue to release that energy as visible light after the energy source is removed, i.e., at nighttime. Advantageously, such an embodiment provides a device that is easy to locate in darkened conditions, making it easy to spot even at nighttime.

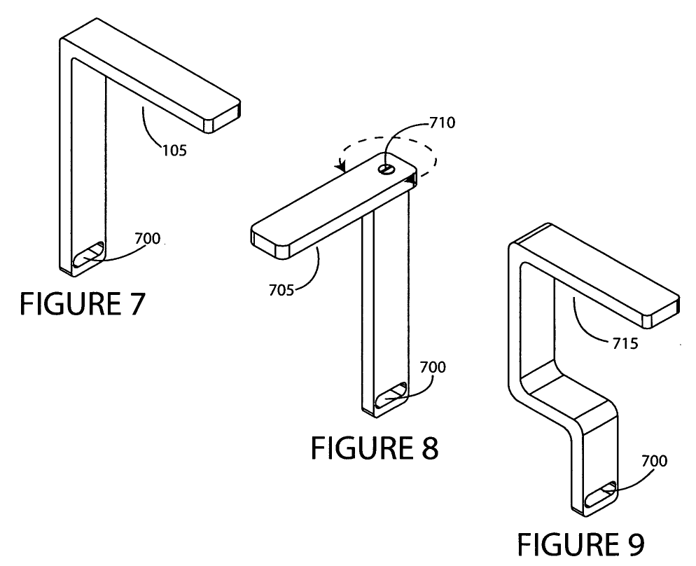

The gate latch extension handle assembly is not limited to a particular shape, nor must the horizontal components be perfectly horizontal or the vertical components perfectly vertical. Additionally, the attachment means apertures need not be circular. FIGS. 7, 8 and 9 show perspective views of exemplary handles (i.e., extension bodies) for an adjustable gate latch extension handle assembly according to principles of the invention. In FIGS. 7 through 9, the latch aperture 700 provided near the free end 117 of the vertical arm as a means for pivotally engaging a hinged catch of a gate latch assembly is elongated. The elongate aperture 700 allows lateral movement of a pivot attachment (e.g., clevis pin) during reciprocating motion. In FIG. 8, the horizontal arm 705 of the extension handle assembly is adjustably (e.g., pivotally) attached to the vertical arm using an adjustable attachment 710 such as a screw. This allows adjustment of the horizontal arm to facilitate grasping. In FIG. 8, the horizontal arm of the extension handle assembly 715 is attached to the vertical arm using at least one intermediate member. In this particular arrangement, a question mark shape is achieved.

The gate latch extension handle assembly 100 may be produced using any suitable manufacturing techniques known in the art for the chosen material, such as (for example) milling, casting, stamping, injection molding, compression molding, structural foam molding, blow molding, transfer molding, or vacuum forming. Preferably, the manufacturing technique is suitable for mass production at relatively low cost per unit, and results in an aesthetically acceptable product with a consistent acceptable quality.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A gate latch extension handle assembly configured for pivotally engaging a latch arm of a hinged catch of a gate latch assembly on a same side of a gate as the gate latch assembly, said gate latch extension handle assembly comprising:
a vertical member having a first width and a first length, a bottom end and a top end, and a means for pivotal attachment to the latch arm of the hinged catch of the gate latch assembly;
a guide bracket having a guide channel sized and shaped to slidingly receive a portion of the vertical member and allow and guide vertical reciprocating movement of the vertical member through said guide channel; and
a horizontal member attached to the top end of and perpendicular to the vertical member, said horizontal member having a second width and a second length, and said vertical member transmitting to said latch arm force exerted on said horizontal member.

2. A gate latch extension handle assembly according to claim 1, the first length being 2 to 12 inches.

3. A gate latch extension handle assembly according to claim 1, the second length being 2 to 6 inches.

4. A gate latch extension handle assembly according to claim 1, further comprising a handgrip surrounding at least a portion of said horizontal member.

5. A gate latch extension handle assembly according to claim 1, further comprising a removable handgrip surrounding at least a portion of said horizontal member.

6. A gate latch extension handle assembly according to claim 1, further comprising an integral handgrip surrounding at least a portion of said horizontal member.

7. A gate latch extension handle assembly according to claim 1, further comprising a handgrip, said hand grip being hollow and including an open end, an interior compartment and an exterior gripping surface, at least a portion of said horizontal member being received through said open end and into said interior compartment.

8. A gate latch extension handle assembly according to claim 1, further comprising a handgrip surrounding at least a portion of said horizontal member, said hand grip comprising an elastomer and a phosphorescent polymer additive in an amount effective to absorb energy from solar radiation and continue to release that energy as visible light in dark conditions.

9. A gate latch extension handle assembly according to claim 1, wherein said guide bracket comprises a u-shaped body defining a vertical guide channel through which a portion of the vertical member is slidingly disposed, said channel having a depth, said depth being greater than the first width of the vertical member, allowing and guiding reciprocating motion of the vertical member without binding.

10. A gate latch extension handle assembly according to claim 1, wherein said guide bracket comprises:
a u-shaped body defining a vertical guide channel through which a portion of the vertical member is slidingly disposed, said channel having a depth, said depth being greater than the first width of the vertical member, allowing and guiding reciprocating motion of the vertical member without binding; and
a pair of mounting tabs extending from opposite sides of said u-shaped body, each of said pair of mounting tabs including at least one mounting hole.

11. A gate latch extension handle assembly according to claim 1, said gate latch extension handle assembly including a phosphorescent polymer coating in an amount effective to absorb energy from solar radiation and continue to release that energy as visible light in dark conditions.

12. A gate latch extension handle assembly according to claim 1, said means for pivotal attachment to the latch arm of the hinged catch of the gate latch assembly comprising a clevis pin and aperture.

13. A gate latch extension handle assembly according to claim 1, said means for pivotal attachment to the latch arm of the hinged catch of the gate latch assembly comprising a clevis pin and circular aperture.

14. A gate latch extension handle assembly according to claim 1, said means for pivotal attachment to the latch arm of the hinged catch of the gate latch assembly comprising a clevis pin and an elongate aperture.

15. A gate latch extension handle assembly according to claim 1, further comprising an adjustable extension means attached to the bottom end of the vertical member.

16. A gate latch extension handle assembly according to claim 1, further comprising a hollow adjustable extension sleeve attached to the bottom end of the vertical member, said extension sleeve including a longitudinal aperture on each of two opposite sides of the extension sleeve, said longitudinal apertures defining a range of adjustment, said sleeve being 3 to 12 inches in length.

17. A gate latch extension handle assembly according to claim 1, further comprising a hollow adjustable extension sleeve attached to the bottom end of the vertical member, said extension sleeve including a longitudinal aperture on each of two opposite sides of the extension sleeve, said longitudinal apertures defining a range of adjustment, and an extension sleeve attachment means for pivotal attachment to the latch arm of the hinged catch of the gate latch assembly.

18. A gate latch extension handle assembly according to claim 1, further comprising a hollow adjustable extension sleeve attached to the bottom end of the vertical member, said extension sleeve including a longitudinal aperture on each of two opposite sides of the extension sleeve, said longitudinal apertures defining a range of adjustment, and an extension sleeve attachment means for pivotal attachment to the latch arm of the hinged catch of the gate latch assembly, said extension sleeve attachment means comprising a clevis pin and an elongate aperture.

19. A gate latch extension handle assembly according to claim 1, said horizontal member being pivotally attached to the top end of and perpendicular to the vertical member.

20. A gate latch extension handle assembly according to claim 1, said horizontal member being attached to the vertical member by at least one intermediate member.
